(19) United States
(12) Patent Application Publication
(10) Pub. No.: US 2010/0246459 A1
(43) Pub. Date: Sep. 30, 2010

(54) Method and System for Reducing Power Consumption in a Wireless Transmitter

(75) Inventors: Hao Ding, Shanghai (CN); Jian-Cheng Huang, Mendham, NJ (US); Jun Li, Shanghai (CN)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Schaumburg, IL (US)

(21) Appl. No.: 12/301,942

(22) PCT Filed: May 10, 2007
(86) PCT No.: PCT/US2007/068622

§ 371 Date: Nov. 21, 2008

(30) Foreign Application Priority Data
May 26, 2006 (CN) 200610087840.1

(51) Int. Cl. H04W 52/02

(52) U.S. Cl. 370/311

(57) ABSTRACT

A system and method for reducing power consumption in a wireless transmitter is useful for conserving battery power in wireless communication devices. The method includes storing a voice data packet in a buffer operatively coupled to the wireless transmitter (step 310). A power supply of the wireless transmitter is then cycled between a high power level and a low power level (step 315). The voice data packet is then transmitted from the buffer to the wireless transmitter when the power supply of the wireless transmitter is at the high power level (step 320).

### FIELD OF THE INVENTION

The present invention relates generally to power management in wireless communication devices. In particular, although not exclusively, the invention relates to reducing power consumption in a wireless transmitter and thus improving power efficiency in a wireless communication device.

### BACKGROUND OF THE INVENTION

Wireless voice communication networks are now a common feature in work, home, and travel environments. For example, mobile telephone networks, Voice over Wireless Local Area Networks (VoWLANs), and ad hoc wireless voice communication networks enable wireless voice communication services to be provided at almost any time and at almost any location. Portable, battery-powered wireless voice communication devices are essential components of many wireless voice communication networks. Such devices include battery-powered mobile phones, two-way radios, personal digital assistants (PDAs), and notebook computers.

Improved device battery technology and improved device energy management has enabled the size and weight of wireless communication devices to be significantly reduced, while the wireless range and maximum operating time of wireless communication devices have significantly increased. However, transmitters that send radio frequency (RF) signals from a wireless communication device still require substantial energy and can account for a high percentage of the total energy consumed by a wireless communication device.

### SUMMARY OF THE INVENTION

According to one aspect, the present invention is a method for reducing power consumption in a wireless transmitter. The method includes storing a voice data packet in a buffer operatively coupled to the wireless transmitter. A power supply of the wireless transmitter is then cycled between a high power level and a low power level. The voice data packet is then transmitted from the buffer to the wireless transmitter when the power supply of the wireless transmitter is at the high power level.

According to another aspect, the invention is a system for reducing power consumption in a wireless transmitter. The system includes a power supply gate operatively coupled to the wireless transmitter, and an audio stream buffer operatively coupled to both the wireless transmitter and to the power supply gate. The power supply gate causes a power supply to the wireless transmitter to cycle between a high power level and a low power level, and voice data packets are transmitted from the audio stream buffer to the wireless transmitter only when the power supply of the wireless transmitter is at the high power level.

The present invention therefore provides a method and system for reducing power consumption in a wireless transmitter of a wireless communication device by reducing a power supply level of the transmitter between voice data packet transmission bursts. Embodiments of the present invention do not have deleterious effects on the quality of transmitted voice data, as the timing of voice data transmissions are unaffected by the present invention, and the wireless transmitter transmits data only while supplied with an effective, high power supply level. Wireless communication devices that employ packet voice applications, such as Institute of Electrical and Electronics Engineers (IEEE) 802.11 (WiFi) and IEEE 802.16 (WiMax) applications are thus able to operate more efficiently and conserve battery power.

### BRIEF DESCRIPTION OF THE DRAWINGS

In order that the invention may be readily understood and put into practical effect, reference now will be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating components of a transmitter system of a wireless communication device, according to an embodiment of the present invention;

FIG. 2 is a timeline illustrating a correspondence between a voice data packet transmission duty cycle of a WiFi module and a power supply level output from a gate and input to the WiFi module, according to an embodiment of the present invention; and

FIG. 3 is a general flow diagram illustrating a method for reducing power consumption in a wireless transmitter, according to an embodiment of the present invention.

FIG. 4 is a schematic diagram further illustrating the functions of a power supply gate, according to an embodiment of the present invention.

FIG. 5 is a block diagram further illustrating the functions of an audio stream buffer, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to reducing power consumption in a wireless transmitter. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as left and right, first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

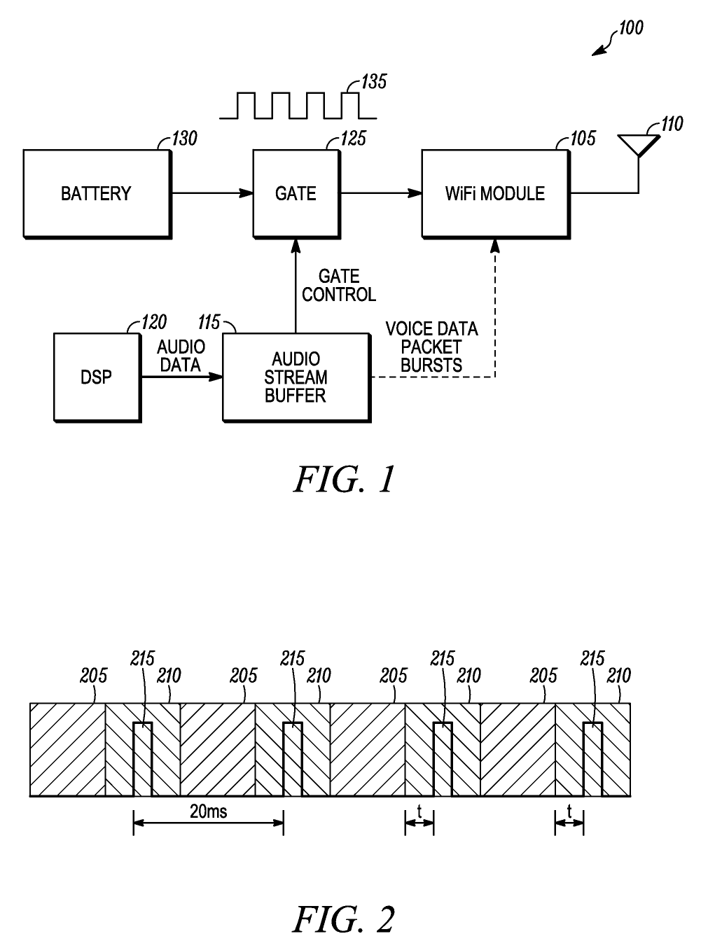

Referring to FIG. 1, a schematic diagram illustrates components of a transmitter system 100 of a wireless communication device, according to an embodiment of the present invention. The transmitter system 100 comprises a wireless transmitter such as an Institute of Electrical and Electronics Engineers (IEEE) 802.11 Wireless Fidelity (WiFi) transceiver module 105. The WiFi module 105 is operatively coupled to an antenna 110 for transmitting radio frequency (RF) signals from the WiFi module 105. An audio stream buffer 115 is also operatively coupled to the WiFi module 105. Audio data from an audio data stream are captured and stored as voice data packets in the audio stream buffer 115. The voice data packets are then cyclically transmitted from the audio stream buffer 115 to the WiFi module 105. The WiFi module 105 then transmits the voice data packets from the antenna 110 using an RF transmission signal.

The WiFi module 105 can function as a conventional Voice over Wireless Local Area Network (VoWLAN) module, which conventional modules are well known to those skilled in the art. That means that the WiFi module 105 transmits cyclical voice data packets using a relatively low-rate voice data duty cycle. According to an embodiment of the present invention, power consumption of the WiFi module 105 is reduced by cycling a power supply of the WiFi module 105 between a high power level and a low power level at a rate that corresponds with the low-rate voice data duty cycle. For example, the high power level corresponds with a designed power supply level that enables the WiFi module 105 to function effectively. The low power level corresponds with an energy conserving power level, between a zero power level and the high power level, that reduces the power consumption of the WiFi module 105 when the module 105 is not transmitting.

Thus the WiFi module 105 is able to function effectively to transmit voice data packets when the power supply of the WiFi module 105 is at the high power level, but the WiFi module 105 does not consume unnecessary power when it is not transmitting. That can reduce total power consumption in wireless communication device such as a mobile phone, two-way radio, personal digital assistant (PDAs), or notebook computer. Cycling of the power supply to the WiFi module 105 is described in further detail below.

The audio data received by the audio stream buffer 115 can comprise various types of digitized audio data formats. For example, many wireless communication devices process digitized audio data using a standard compression/decompression (codec) algorithm, such as an algorithm that conforms to the International Telecommunication Union (ITU) G.729 codec standard. Such an algorithm can be executed using a digital signal processor (DSP) 120 that is a further component of the wireless communication device that comprises the transmitter system 100. The audio data can thus comprise a continuous voice data stream that is input to the audio stream buffer 115.

A power supply gate 125 is operatively coupled to a power source, such as a battery 130, of the transmitter system 100. The gate 125 is then further operatively coupled to both the audio stream buffer 115 and to the WiFi module 105. The gate 125 thus controls the power supply level input to the WiFi module 105. The gate 125 receives a relatively steady state power supply level from the battery 130, and outputs a cyclical power supply level, such as illustrated by the square wave 135 in FIG. 1, to the WiFi module 105.

A frequency and phase of the power supply output of the gate 125 can be controlled by a gate control signal that is transmitted from the audio stream buffer 115 to the gate 125. The frequency of the power supply output of the gate 125 generally corresponds with a voice data packet transmission duty cycle of the WiFi module 105, and the phase of the power supply output of the gate 125 generally corresponds with a voice data packet transmission phase of the WiFi module 105. That ensures that the WiFi module 105 is maintained at an acceptable operating power level during transmission of voice data packets from the WiFi module 105, while enabling the WiFi module 105 to be powered down to a low power level when it is not transmitting.

For example, an ITU G.729 codec operates at a voice data transfer rate of eight kilo bytes per second (8 kbps), which is significantly lower than a typical data transfer rate of an IEEE 802.11 WiFi transceiver such as the WiFi module 105. A data transfer rate of the WiFi module 105 is generally at least an order of magnitude higher and is measured in mega bytes per second (Mbps). That means that a voice data stream output from a G.729 codec can be transmitted in real-time, after being converted to voice data packets, using only periodic short transmission bursts from the WiFi module 105. Between such transmission bursts, the WiFi module 105 does not require a high power supply level and can be powered down to a low power supply level.

Referring to FIG. 2, a timeline illustrates a correspondence between a voice data packet transmission duty cycle of the WiFi module 105 and a power supply level output from the gate 125 and input to the WiFi module 105, according to an embodiment of the present invention. Low power periods 205 indicate a cyclical drop in the power supply to the WiFi module 105 to a low power level, and high power periods 210 indicate a cyclical increase in the power supply to the WiFi module 105 to a high power level. Square wave blocks 215 indicate periods when the WiFi module 105 is transmitting voice data packets. Thus, as shown, voice data packets are transmitted only in periodic bursts, when the WiFi module 105 is operating at a high power level. For example, when transmitting voice data from an ITU G.729 codec, the high power periods 210 can be spaced apart by 20 ms and the voice data transmissions indicated by the square wave blocks 215 can be spaced apart by 20 ms, equivalent to a duty cycle of 50 Hz. As will be appreciated by those skilled in the art, the durations of the low power periods 205 are not necessarily equal to the durations of the high power periods 210, and the relative durations can be tailored depending on the requirements of a particular system.

According to an embodiment of the present invention a high power level is first provided to the WiFi module 105 at a period of time (illustrated in FIG. 2 by the periods t) before voice data packets are first transmitted from the WiFi module 105. That enables the WiFi module 105 to ramp up from a low power level to an effective operating state before transmitting voice data packets.

As will be readily understood by those skilled in the art, the WiFi module 105 has been described as a component of one illustrative embodiment of the present invention, and power consumption in other types of wireless transmitters also can be reduced by employing the teachings of the present invention. For example, a wireless transmitter according to an embodiment of the present invention can comprise an IEEE 802.16 Worldwide Interoperability for Microwave Access (WiMAX) transceiver or various other types of broadband transmitters. Further, according to alternative embodiments of the present invention, wave types other than a square wave can be used to cycle the power supply level of a wireless transmitter. For example, rather than using step function responses based on a square wave, according to some embodiments of the present invention, and depending on the operating characteristics of a wireless transmitter, a power supply level can be ramped up gradually from a low power level to a high power level.

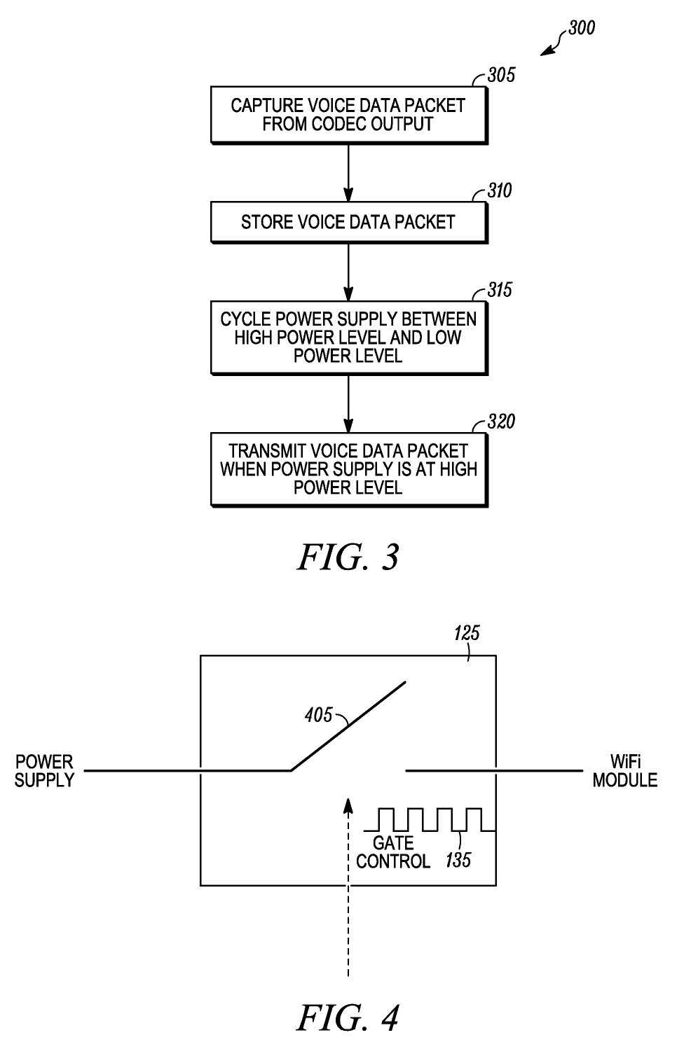

Referring to FIG. 3, a general flow diagram illustrates a method for reducing power consumption in a wireless transmitter, according to an embodiment of the present invention. At step 305, a voice data packet is captured from a voice data stream output from a codec algorithm. For example, the DSP 120 executes a codec algorithm that conforms to an ITU G.729 codec standard and transmits a resulting voice data stream output to the audio stream buffer 115 where particular voice data packets are captured. At step 310 the voice data packet is stored in a buffer operatively coupled to the wireless transmitter. For example, the voice data packet is stored in the audio stream buffer 115 that is operatively coupled to the WiFi module 105. At step 315, a power supply of the wireless transmitter is cycled between a high power level and a low power level. For example, the gate 125 cycles power from the battery 130 between an operating power level of the WiFi module 125 and a zero power level based on a gate control signal received from the audio stream buffer 115. At step 320, the voice data packet is transmitted from the buffer to the wireless transmitter when the power supply of the wireless transmitter is at the high power level. For example, the audio stream buffer 115 waits for a predetermined time period (t) after the WiFi module 105 has been cycled to the high power level, to enable the WiFi module 105 to ramp up to an effective operating state, and then transfers the voice data packet to the WiFi module 105. The data packet is then transmitted using a radio frequency (RF) signal generated in the WiFi module 105.

Referring to FIG. 4, a schematic diagram further illustrates the functions of the power supply gate 125, according to an embodiment of the present invention. For example, the gate 125 can comprise a simple electrical switch 405 that is oscillated between an open and a closed position based on the amplitude of a gate control signal such as the square wave 135. In such an embodiment of the present invention, the cyclical power supply level output to the WiFi module 105 therefore conforms to the gate control signal and also would be represented by a square wave.

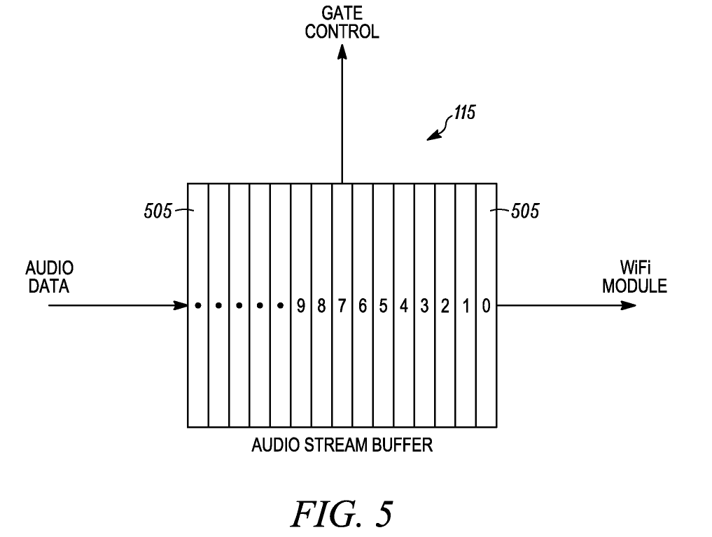

Referring to FIG. 5, a block diagram further illustrates the functions of the audio stream buffer 115, according to an embodiment of the present invention. The audio stream buffer 115 can comprise, for example, portions of a standard system memory, such as a random access memory (RAM) in a wireless communication device. The audio stream buffer 115 is then segmented into memory blocks 505, where each block 505 corresponds to a voice data packet that is received from the DSP 120. As described above, the rate at which the voice data packets are transmitted from the audio stream buffer 115 to the WiFi module 105 then can be correlated to a frequency of the gate control signal that is transmitted to the gate 125. As illustrated in FIG. 2, the frequency of the power supply level input to the WiFi module 105 can be identical to the frequency of the voice data packet transmission from the WiFi module 105. The gate control signal and the voice data packet transmission are then maintained out of phase by the time period t, which ensures that the WiFi module 105 is in an effective operating state when it receives the voice data packets from the audio stream buffer 115.

The present invention therefore provides a method and system for reducing power consumption in a wireless transmitter by reducing a power supply level of the transmitter between voice data packet transmission bursts. Embodiments of the present invention do not have deleterious effects on the quality of transmitted voice data, as the timing of voice data transmissions are unaffected by the present invention, and the wireless transmitter transmits data only while supplied with an effective, high power supply level. Wireless communication devices that employ packet voice applications, such as IEEE 802.11 (WiFi) and IEEE 802.16 (WiMax) applications are thus able to operate more efficiently and conserve battery power.

The above detailed description provides an exemplary embodiment only, and is not intended to limit the scope, applicability, or configuration of the present invention. Rather, the detailed description of the exemplary embodiment provides those skilled in the art with an enabling description for implementing the exemplary embodiment of the invention. It should be understood that various changes can be made in the function and arrangement of elements and steps without departing from the spirit and scope of the invention as set forth in the appended claims. It will be appreciated that embodiments of the invention described herein may be comprised of one or more conventional processors and unique stored program instructions that control the one or more processors to implement, in conjunction with certain non-processor circuits, some, most, or all of the functions of reducing power consumption in a wireless transmitter as described herein. The non-processor circuits may include, but are not limited to, a radio receiver, a radio transmitter, signal drivers, clock circuits, power source circuits, and user input devices. As such, these functions may be interpreted as steps of a method for reducing power consumption in a wireless transmitter. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for reducing power consumption in a wireless transmitter, the method comprising:
storing a voice data packet in a buffer operatively coupled to the wireless transmitter;
cycling a power supply of the wireless transmitter between a high power level and a low power level; and
transmitting the voice data packet from the buffer to the wireless transmitter when the power supply of the wireless transmitter is at the high power level.

2. The method of claim 1, wherein the wireless transmitter is an Institute of Electrical and Electronics Engineers 802.11 Wireless Fidelity transceiver, or an Institute of Electrical and Electronics Engineers 802.16 Worldwide Interoperability for Microwave Access transceiver.

3. The method of claim 1, further comprising:
capturing the voice data packet from a voice data stream output from a compression/decompression algorithm of a digital signal processor.

4. The method of claim 3, wherein the codec algorithm conforms to an International Telecommunication Union G.729 codec standard.

5. The method of claim 1, wherein the low power level is a zero power level.

6. The method of claim 1, wherein the power supply of the wireless transmitter is cycled according to a square wave.

7. The method of claim 1, wherein the power supply of the wireless transmitter is cycled using a power supply gate.

8. The method of claim 1, wherein the power supply of the wireless transmitter is cycled at a frequency that is less than 100 Hz.

9. The method of claim 1, wherein the power supply of the wireless transmitter is cycled at a frequency of about 50 Hz.

10. The method of claim 1, wherein the wireless transmitter is a component of a wireless communication device that executes a voice over wireless local area network application.

11. A system for reducing power consumption in a wireless transmitter, the system comprising:
a power supply gate operatively coupled to the wireless transmitter; and
an audio stream buffer operatively coupled to both the wireless transmitter and to the power supply gate;
wherein the power supply gate causes a power supply to the wireless transmitter to cycle between a high power level and a low power level, and voice data packets are transmitted from the audio stream buffer to the wireless transmitter only when the power supply of the wireless transmitter is at the high power level.

12. The system of claim 11, wherein the wireless transmitter is an Institute of Electrical and Electronics Engineers 802.11 Wireless Fidelity transceiver, or an Institute of Electrical and Electronics Engineers 802.16 Worldwide Interoperability for Microwave Access transceiver.

13. The system of claim 11, wherein the low power level is a zero power level.

14. The system of claim 11, wherein the power supply of the wireless transmitter is cycled at a frequency that is less than 100 Hz.

15. The system of claim 11, wherein the wireless transmitter is a component of a wireless communication device that executes a voice over wireless local area network application.
